(19) United States
(12) Patent Application Publication
(10) Pub. No.: US 2010/0007210 A1
(43) Pub. Date: Jan. 14, 2010

(54) GREEN POWER SYSTEM

(76) Inventor: David Van Akin, Shelton, CT (US)

Correspondence Address: Perman & Green, LLP, 99 Hawley Lane, Stratford, CT, 06614, US

(21) Appl. No.: 12/502,306

(22) Filed: Jul. 14, 2009

Related U.S. Application Data
(60) Provisional application No. 61/080,471, filed on Jul. 14, 2008.

(51) Int. Cl. H02J 3/14

(52) U.S. Cl. 307/39

(57) ABSTRACT

A power distribution system including a first power distribution unit connected to a power supply and a second power distribution unit connected to the first power distribution unit, the second power distribution unit being configured to split power provided from the first power distribution unit into a constant power source and a selectively active power source.

### CROSS-REFERENCE TO RELATED APPLICATIONS

This application claims the benefit of U.S. Provisional Patent Application No. 61/080,471, filed on Jul. 14, 2008, the disclosure of which is incorporated by reference herein in its entirety.

### BACKGROUND

1. Field

The exemplary embodiments generally relate to conveying power through a building and, more particularly, to selectively conveying that power.

2.Brief Description of Related Developments

With increasing energy costs and rising pollution concerns, consumers of electrical power are taking measures to conserve energy and manage their power consumption. Generally, when an appliance is not in use the power conscious consumer unplugs that appliance from the power source. However, repetitive unplugging and plugging in of the appliances causes wear and tear on the electrical contacts within the power outlets or receptacles as well as the prongs on the power cords for the appliance. Further, the power outlets may be located behind a large appliance (such as an entertainment center, stove, etc.) that is not easily moveable for accessing the power outlet. Also, generally power receptacles cannot be disconnected from the power supply without tripping the circuit breaker to which the receptacle is connected. However, tripping the circuit breaker not only disconnects a desired receptacle from the power supply but also disconnects every receptacle connected to the circuit breaker from the power supply. Generally, caps or covers are inserted into receptacles to prevent discharge of power from a receptacle to an object inserted into the receptacle but these covers are easily removed and/or lost.

It would be advantageous to conveniently and easily selectively control the application of power to appliances.

### SUMMARY

In one exemplary embodiment, a power distribution system is provided. The power distribution system includes a power distribution system including a first power distribution unit connected to a power supply and a second power distribution unit connected to the first power distribution unit, the second power distribution unit being configured to split power provided from the first power distribution unit into a constant power source and a selectively active power source.

In another exemplary embodiment, a power distribution system is provided. The power distribution system includes a housing, a power cord extending from the housing, the power cord being configured to engage a power receptacle for providing power to the power distribution system, a power distribution unit disposed within the housing and coupled to the power cord, the power distribution unit being configured to split power provided by the power cord into a constant power source and a selectively active power source, and at least one power receptacle accessibly mounted to the housing, the at least one power receptacle being connected to the constant power source and the selectively active power source for selectively switching between at least a constant power source mode and a selectively active power source mode.

In yet another exemplary embodiment, a method for providing power to a power distribution system is provided. The method includes providing a power supply to a first power distribution unit and splitting, with a second power distribution unit, power supplied from the first power distribution unit into a constant power source and a selectively active power source.

### BRIEF DESCRIPTION OF THE DRAWINGS

The foregoing aspects and other features of the disclosed embodiments are explained in the following description, taken in connection with the accompanying drawings, wherein:

FIG. 1 is a schematic illustration of an electrical power distribution system in accordance with an exemplary embodiment; and

FIG. 2 is a schematic illustration of a power strip in accordance with an exemplary embodiment.

### DETAILED DESCRIPTION OF THE EXEMPLARY EMBODIMENT(S)

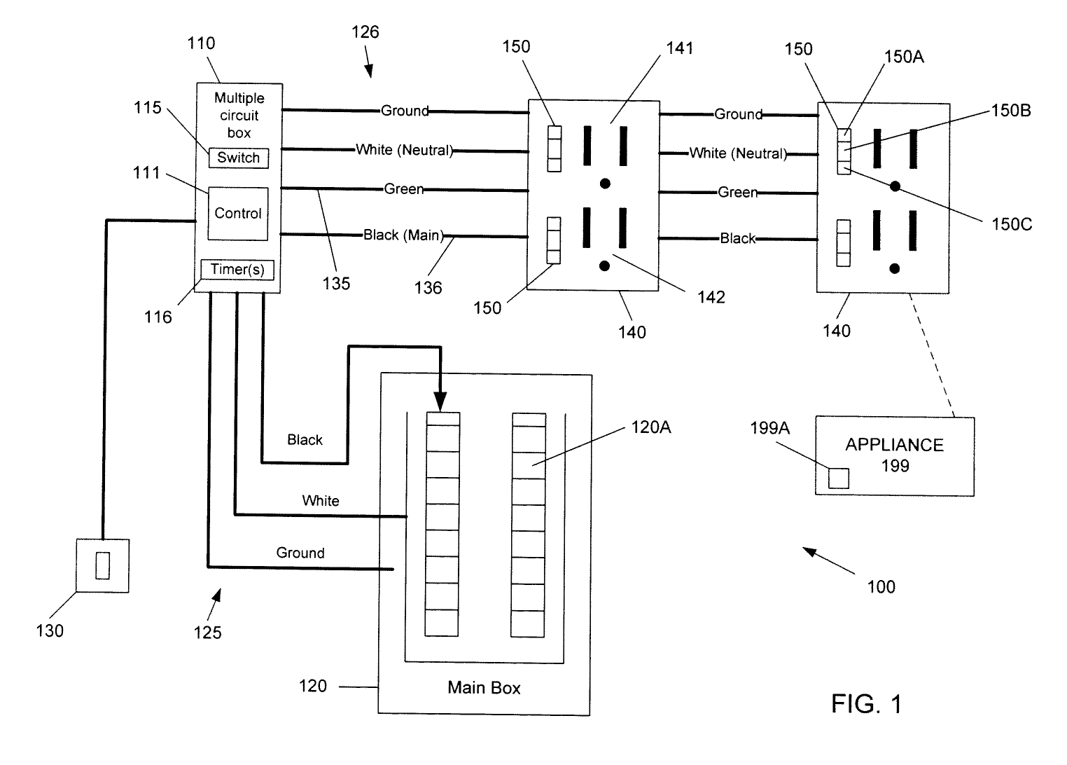

FIG. 1 is a schematic illustration of an electrical power distribution system 100 in accordance with an exemplary embodiment. Although the disclosed embodiments will be described with reference to the embodiments shown in the drawings, it should be understood that the disclosed embodiments can be embodied in many alternate forms. In addition, any suitable size, shape or type of elements or materials could be used.

Although the power distribution system 100 of the exemplary embodiments will be described with respect to a power distribution system of a building structure, it should be realized that the exemplary embodiments can be applied to any suitable power distribution system. As a non-limiting example, suitable power distribution systems may also include mobile power distribution systems such as in a recreational vehicle, airplane, train, or boat.

The power distribution system 100 shown in FIG. 1 allows a user of the system to selectively control the application of power to one or more appliances 199 connected to the power system 100. As used herein the term “appliance” can be any suitable electrical device that can be coupled to the power system including, but not limited to, major appliances (e.g. refrigerators, clothes washers and dryers, etc.), small appliances (e.g. coffee makers, toasters, etc.), lights, televisions, radios, game systems, video recorders/players, computers, etc. The power system 100 provides different modes of operation such that in a first mode of operation power is supplied in a constant state to one or more appliances 199 (e.g. the power is always on). In a second mode of operation power is not transmitted to one or more appliances 199 (e.g. the power is off so that the appliance 199 cannot draw any current from the power system 100). In a third mode of operation the power is selectively applied to one or more appliances 199 to manage power consumption by the appliance 199 in any suitable manner as will be described in greater detail below. In alternate embodiments, the power distribution system may have more or less than three modes of operation.

As can be seen in FIG. 1, the power distribution system 100 includes a main circuit breaker box 120, a multiple circuit box 110, power outlets or receptacles 140 and mode switches 130, 150. It should be realized that the components of the power distribution system 100 are merely exemplary in nature and in alternate embodiments the power system 100 may have any suitable combination of components. The main circuit breaker box 120 may be a conventional breaker box including circuit breakers 120A for the various power circuits within or external to a building structure. For ease of explanation only one set of wires 125 is shown exiting the main circuit breaker box 120 but it should be realized that there may be a set of wires corresponding to each of the circuit breakers 120A within the box 120. As can be seen in FIG. 1, the set of wires 125 exiting the main circuit breaker box 120 includes a black (hot) wire, a white (neutral) wire and a ground wire. As can be seen in FIG. 1, the power distribution system 100 is shown as a 120V power system but in alternate embodiments the power system may include any suitable combination of circuits having any suitable voltage and current levels. It is noted that the color convention and number of wires described herein is merely exemplary and the sets of wires exiting the main circuit breaker box may have any suitable color convention and number. For example, outside of the United States a different color convention may be used and a different number of wires may be used for different circuits having a predetermined voltage/current rating. The set of wires 125 connects the main circuit breaker box 120 with the multiple circuit box 110. As noted above, a set of wires may pass between the main circuit breaker box 120 and the multiple circuit box 110 for each electrical circuit/breaker.

Although the multiple circuit box 110 is shown as a being separate from the main circuit breaker box 120, in alternate embodiments the multiple circuit box may be incorporated into or be integrated into the main circuit breaker box or vice versa. The multiple circuit box 110 is configured to split the black wire into a first and second hot wire. The first hot wire corresponds to the black wire and will be referred to herein as a black (hot) wire 136 that is substantially similar to the black wire in the wire set 125. The second hot wire will be referred to herein as a “green” wire 135. The green wire may be connected to one or more switches and/or timers for selectively applying power to one or more appliances 199. For example, in one exemplary embodiment, each electrical circuit may have a corresponding switch 115 and/or timer 116 for selectively applying power to that circuit. In another exemplary embodiment there may be one switch 115 and/or timer 116 for selectively applying power to all of the electrical circuits running through the multiple circuit box 110. In alternate embodiments there may be any suitable number of switches and/or timers for controlling one or more electrical circuits. In one embodiment, the switch 115 and/or timer 116 may be located at or be integrated with the multiple circuit box 110. In another exemplary embodiment, there may be one or more switches 130 located remotely from the multiple circuit box 110 that may allow the user to control, for example, the green mode of operation (or any other operation) of the power distribution system 100 without having to be at the location of the multiple circuit box (e.g. the switch 130 may be in a different room, on a different floor, etc. of, for example, the building than the multiple circuit box 110). In still another exemplary embodiment, the power distribution system 100 may include a combination of switches/timers located at the multiple circuit box and remotely located switches.

As may be realized, in one exemplary embodiment, the multiple circuit box 110 may include a controller 111 coupled to the one or more switches 115, 130 and or timers 116. In other exemplary embodiments the multiple circuit box 110 may not have a controller such that the switches and timers are connected to a corresponding green circuit via any suitable connector such as, for example, an electrical terminal. In one example, the controller 111 may be any suitable electronic controller allowing multiple timers 116 to be set where each of those timers can be associated with a respective one or more circuits. The timers 116 may be incorporated into or separate from the electronic controller 111. In other exemplary embodiments, the timers 116 may be mechanical devices, eletro-mechanical devices or electrical devices that are operated by a respective one of the switches 115, 130. The switches 115, 130 and/or timers 116 may be configured to cause power to flow to the green wire 135 for selectively controlling power consumption by the appliance(s) 199. In one embodiment, power will always flow through the black wire 136 even when power is applied to the green wire 135 via the switch/timer. In alternate embodiments, the switch/timer may be configure to transfer power from the black wire 136 to the green wire 135 so that power flows through only one of the green or black wires 135, 136 at a time.

As can be seen in FIG. 1, a single set of four wires 126 is shown exiting the multiple circuit box 110 for ease of explanation and for exemplary purposes only. As noted above, there may be a set of wires for each electrical circuit leaving the multiple circuit box 110. In alternate embodiments, the wire set 126 may have any suitable number of wires depending on the power requirements and type of electrical circuit and any suitable color convention. The set of wires 126 will be referred to herein as the green wire set 126. The green wire set 126 includes the black wire 136, the green wire 135, a white (neutral) wire and a ground wire. The white wire and ground wire in the green wire set 126 correspond to and are a continuation of the white wire and ground wire respectively from wire set 125. It is noted that the wire sets 125, 126 may be connected to each other in any suitable manner such as, for example, through a terminal block, in for example, the multiple circuit box 110. As may be realized the terminal block may allow for the splitting of the black wire in wire set 125 to the green and black wires of wire set 126.

The wire set 126 may connect one or more power outlets or receptacles 140 to the multiple circuit box 110. The power outlets shown in FIG. 1 are illustrated as wall outlets for exemplary purposes only. In alternate embodiments the power outlets may be any suitable outlets including power strips as will be described below. In alternate embodiments the appliances 199 may be hard wired into the power distribution system 100. In one example, an appliance 199 may be hard wired to the constant power circuit or the green power circuit. In another example, the appliance 199 may include a mode selector switch 199A substantially similar to mode selector switch 150 described herein. Each of the power outlets 140 may include one or more mode selector switches 150 for controlling how power is supplied to a respective receptacle. In this example, each receptacle 141, 142 of outlet 140 has a respective switch 150. In other exemplary embodiments, there may be one switch located on the outlet that controls any suitable number receptacles located on that outlet. For example, the outlet 140 may have one switch 150 for controlling all of the receptacles 141, 142 located on that outlet 140. The switch 150 may have multiple positions 150-150c corresponding to the modes of operation of the power distribution system 100. For exemplary purposes only, the switch 150 may have a first position 150A corresponding to a constant power supply, a second position 150B corresponding to a no power condition and a third position 150C corresponding to a green power supply. When the switch 150 is in the first position 150A the receptacle corresponding to the switch 150 draws constant power from the black wire 136. When the switch 150 is in the second position 150B the receptacle is disconnected from both the green wire 135 and the black wire 136 so that the respective receptacle cannot draw any power. The switch may be configured with any suitable lockout device to prevent unauthorized switching of the switch from the second position. In one exemplary embodiment, the lock out device may be a substantially child proof device so that a child is unable to cause power to flow to the corresponding receptacle. When the switch 150 is in the third position 150C the receptacle draws power from the green wire 135. In one exemplary embodiment, the switch may include any suitable environmentally friendly indicator to indicate to a user which power mode the receptacle is in. For example, when switch in the green mode (e.g. switch is at the third position) a green light emitting diode (LED) may light, when the power is not applied to the receptacle (e.g. switch is at the second position) a red LED may light up, and so on. It should be realized that the color of the LED indicators is merely for exemplary purposes only and each switch position may have any suitable color indicator. In alternate embodiments, there may be a colored plate under the switch so that as the switch is moved to different positions a different portion of the color place is visually exposed to indicate the mode of operation of the switch. In alternate embodiments the indicator may be any suitable visual indicator, tactile indicator, audible indicator or any combination thereof.

In one exemplary operation, a user may set each receptacle 141, 142 to any suitable desired mode of operation (e.g. off, green, or constant) . As a non-limiting example, receptacles used for electronic clocks may be set to the constant power mode whereas receptacles used for televisions may be set to the green power mode to prevent unnecessary current draw from an appliance 199 that is not on. In one exemplary embodiment, the power distribution system 100 may be configured so that the green power circuit normally operates on a timer 116 where the switch 115, 130 overrides the timer 116 for applying or not applying power to the green circuits. In alternate embodiments the switches 115, 130 and corresponding timers 116 may be interconnected in any suitable manner for selectively applying power to the green circuits at any desired times.

In this example, when the green circuit is activated, via the switch 115, 130 and/or timer 116, the receptacles 141, 142 set on the green mode via switch 150 are energized so that appliances 199 connected to these receptacles can be operational. Likewise, when the green circuit is deactivated, via the switch 115, 130 and/or timer 116, the corresponding receptacles 141, 142 are de-energized so that the appliances 199 connected to these receptacles are inoperable and do not draw any current. It is noted that the receptacles set to the constant mode via the switch 150 are unaffected by the activation/deactivation of the green circuit as these receptacles are connected to the black wire 136 which, as described above provides a constant supply of power. The receptacles set to off via the switch 150 are also unaffected by the activation/deactivation of the green circuits as these receptacles are not connected to either of the green or black wires 135, 136.

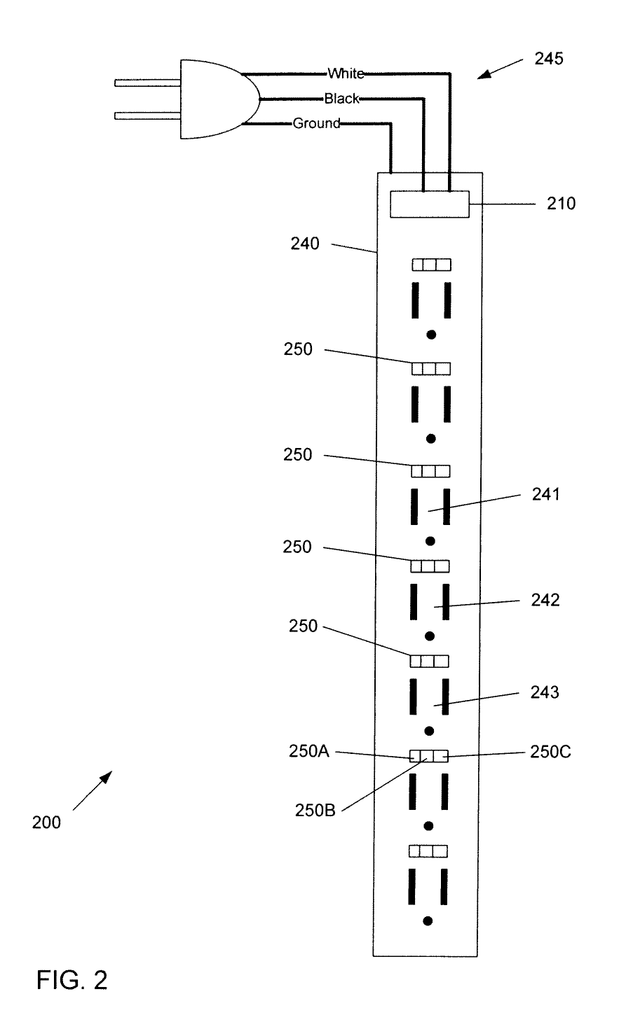

Referring now to FIG. 2, another exemplary embodiment of the green power distribution system is shown. In this exemplary embodiment the green power distribution system is in the form of a power strip 200. The power strip 200 may be connected to any suitable power receptacle, such as for example, a conventional power receptacle (e.g. a receptacle that always has power connected to it). As can be seen in FIG. 2, the power strip 200 includes a power strip housing 240 and a power cord 245. The power cord, for exemplary purposes only, includes a white (neutral) wire, a black (hot) wire and a ground wire, that correspond to the hot, neutral and ground wires existing a conventional circuit breaker box substantially similar to circuit breaker box 120. The power strip housing 240 may include one or more receptacles 241-243 and corresponding switches 250. The switches 250 and receptacles 241-243 may be substantially similar to receptacles 141, 142 and switches 150. The power strip housing 240 may also include the components of the multiple circuit box 110 described above with respect to FIG. 1 such that the black wire of the power cord is split into a green wire and a second black wire substantially similar to green wire 135 and black wire 136 described above. The power strip housing 240 also includes a switch/timer 210 substantially similar to switches 115, 130 and timer 116 described above. In operation, each of the receptacles 241-243 can be set to a green, constant or off mode of operation as described above with respect to FIG. 1 such that each mode of operation is selected by moving the switches to a respective one of the first second and third positions 250A-250C in a manner substantially similar to that described above with respect to switch 150. When the switch/timer 210 is activated power is provided to the receptacles 241-243 that are set to the green mode, receptacles 241-243 that are set to the constant mode receive a constant supply of power and receptacles set to the off mode do not receive power as they are disconnected from both the green and second black wire.

The exemplary embodiments provide a user of an electrical power distribution system 100 of, for example, a building to selectively apply power to appliances 199 located within or outside the building (as long as those appliances 199 are connected to the power distribution system). In accordance exemplary embodiments, appliances 199 that require a constant power supply can be constantly powered, while appliances 199 that do not require constant power can be easily and conveniently disconnected from the power supply. This substantially eliminates unnecessary power consumption, such as the power consumed by electronic devices when they are “powered off” or not in use. This elimination of unnecessary power consumption not only decreases power demands and pollution associated with power production but also saves the user of the power distribution system money as they do not have to pay for power drawn by a device that is not in use. The exemplary embodiments also provide for disconnecting a receptacle from the power supply.

It should be understood that the exemplary embodiments can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A power distribution system comprising:
a first power distribution unit connected to a power supply; and
a second power distribution unit connected to the first power distribution unit, the second power distribution unit being configured to split power provided from the first power distribution unit into a constant power source and a selectively active power source.

2. The power distribution system of claim 1, wherein the second power distribution unit comprises a controller configured to selectively provide power to the selectively active power source.

3. The power distribution system of claim 2, wherein the second power distribution unit comprises at least one timer coupled to the controller, the timer being configured to effect providing power to the selectively active power source at predetermined times.

4. The power distribution system of claim 2, wherein the second power distribution unit comprises at least one switch coupled to the controller, the at least one switch being configured to selectively provide power to the selectively active power source.

5. The power distribution system of claim 1, wherein the second power distribution unit comprises at least one of a switch and a timer located remotely from a housing of the second power distribution system, the at least one of the switch and the timer being configured to effect selectively providing power to the selectively active power source.

6. The power distribution system of claim 1, further comprising a housing wherein the first and second power distribution units are disposed within the housing.

7. The power distribution system of claim 1, further comprising at least one power receptacle connected to the constant power source and the selectively active power source, the at least one power receptacle being configured to selectively switch between at least a constant power source mode and a selectively active power source mode.

8. The power distribution system of claim 7, wherein the power receptacle comprises a switch for effecting switching between the constant power source mode, the selectively active power source mode and a no power source mode.

9. The power distribution system of claim 8, wherein the switch comprises a multi-position switch having at least one of a visual indicator, a tactile indicator and an audible indicator corresponding to each of the constant power source mode, the selectively active power source mode and the no power source mode.

10. The power distribution system of claim 8, wherein the switch comprises a lock out device configured to substantially prevent switching of the switch from the no power source mode.

11. The power distribution system of claim 1, wherein the power distribution system is configured for installation within a stationary building structure or a mobile structure.

12. A power distribution system comprising:
a housing;
a power cord extending from the housing, the power cord being configured to engage a power receptacle for providing power to the power distribution system;
a power distribution unit disposed within the housing and coupled to the power cord, the power distribution unit being configured to split power provided by the power cord into a constant power source and a selectively active power source; and
at least one power receptacle accessibly mounted to the housing, the at least one power receptacle being connected to the constant power source and the selectively active power source for selectively switching between at least a constant power source mode and a selectively active power source mode.

13. The power distribution system of claim 12, wherein the power distribution unit comprises a controller configured to selectively provide power to the selectively active power source.

14. The power distribution system of claim 13, wherein the power distribution unit comprises at least one timer coupled to the controller, the timer being configured to effect providing power to the selectively active power source at predetermined times.

15. The power distribution system of claim 13, wherein the second power distribution unit comprises at least one switch coupled to the controller, the at least one switch being configured to provide power to the selectively active power source.

16. The power distribution system of claim 12, wherein the at least one power receptacle comprises a switch for effecting switching between the constant power source mode, the selectively active power source mode and the no power source mode.

17. The power distribution system of claim 16, wherein the switch comprises a multi-position switch having at least one of a visual indicator, a tactile indicator and an audible indicator corresponding to each of the constant power source mode, the selectively active power source mode and a no power source mode.

18. The power distribution system of claim 16, wherein the switch comprises a lock out device configured to substantially prevent switching of the switch from the no power source mode.

19. A method for providing power to a power distribution system, the method comprising:
providing a power supply to a first power distribution unit;
splitting, with a second power distribution unit, power supplied from the first power distribution unit into a constant power source and a selectively active power source.

20. The method of claim 19, further comprising selectively switching between at least a constant power source mode and a selectively active power source mode with a switch located at a receptacle of the power distribution system, wherein the switch is coupled to the constant power source and the selectively active power source from the second power distribution unit.
